(19) United States
(12) Patent Application Publication
(10) Pub. No.: US 2007/0273919 A1
(43) Pub. Date: Nov. 29, 2007

(54) Network Device Management Apparatus And Its Control Method, Computer Program and Computer-Readable Storage Medium

(75) Inventor: Hiroshi Oomura, Kanagawa-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/599,653

(22) PCT Filed: Apr. 8, 2005
(86) PCT No.: PCT/JP05/07282

§ 371 Date: Oct. 4, 2006

(30) Foreign Application Priority Data
Apr. 19, 2004 (JP) 2004-123443

(51) Int. Cl. B41B 1/02

(52) U.S. Cl. 358/1.15

(57) ABSTRACT

The present invention makes other devices on a network recognize a device that does not support the network compatible Plug and Play function as a device that supports the network compatible Plug and Play function, and makes that device serve as the device with the function. To this end, a proxy server searches for a printer which is present on the network and does not support any network compatible Plug and Play function, and registers information used to specify the found printer in a hard disk via a memory controller. Upon registration, the proxy server generates network compatible Plug and Play DeviceDEscription so as to behave as if it were a network compatible Plug and Play device. Upon reception of a network compatible Plug and Play search message from the network, the proxy server transmits the generated DeviceDEscription as a response message to indicate a UPnP device in place of the printer that does not support the network compatible Plug and Play device. Upon reception of a print job addressed to the registered printer, the proxy server converts the print job to a protocol for that printer, and transmits the converted job data to the printer.

### TECHNICAL FIELD

The present invention relates to a technique for managing network devices.

### BACKGROUND ART

A print apparatus has a command interface as a unique rendering language system such as PDL (Page Description Language) or the like, so as not to depend on a specific information processing apparatus, an operating system (to be abbreviated as an OS hereinafter) that runs on the information processing apparatus, or an application that runs on that OS.

The rendering language system depends on each individual print apparatus. To encapsulate that dependence, the OS defines a module called a printer driver which has a standard rendering interface as an input, converts the input into a command of a print apparatus-dependent rendering language system, and outputs that command. The printer driver is normally created by the vendor of a print apparatus, OS developer, or the like, and is stored in an information processing apparatus.

There are many printer drivers stored in the information processing apparatus. For this reason, presenting all the printer drivers stored in the information processing apparatus creates user's confusion. That is, it is desired that a printer driver be efficiently related to only a print apparatus used by the user, and be set to be usable by the user. Hence, a printer driver is merely stored in the information processing apparatus in a default state of the OS, and the user must perform installation of the printer driver to the OS as an operation for relating the printer driver to a specific print apparatus.

Conventionally, the user manually makes this installation process. However, the user must make a complicated installation process of a printer driver. When a command of another rendering language system is sent to a print apparatus which does not support that rendering language system, a print error occurs. In that case, the user must correctly install a printer driver corresponding to the print apparatus, and such process is difficult for beginners.

In order to reduce the load on such complicated installation process, an OS is introduced with a function of automatically making two-way communications between an information processing apparatus and print apparatus without any user's operation and installing a driver corresponding to the print apparatus in the information processing apparatus by only connecting the information processing apparatus and print apparatus via a communication medium such as a parallel interface complying with the specification of Centronics Datacomputer Inc., USB interface, or the like. This function will be referred to as a Plug and Play function (e.g., Japanese Patent Laid-Open No. 2003-216378).

The Plug and Play function is attained by a direct one-to-one connection. In recent years, along with building of the network infrastructures, network peripheral devices such as network compatible print apparatuses, scanners, copying machine, and the like have rapidly spread. Also, techniques for searching for devices that provide various services on the network via the network have been developed. For example, as such technique, a Universal Plug and Play (to be abbreviated as UPnP hereinafter) proposed by Microsoft Corporation is available (e.g., Japanese Patent Laid-Open No. 2003-6133).

Taking, as an example, a print apparatus as network compatible network devices, the corresponding driver registered and managed on the database is installed in advance by an operating system (e.g., Windows®) that runs on a client (e.g., a personal computer) which is to be used, or driver software (driver) provided via a recording medium such as a flexible disk, CD-ROM, or the like from a print apparatus vendor is installed. After that, information required to operate the print apparatus such as an IP address assigned to the print apparatus, a printer port, a print protocol to be used, device driver, and the like, must be recognized.

In consideration of an ever-changing configuration of devices connected to a network system (e.g., by moving the print apparatus to another network, adding a new print apparatus to the network, and so forth), a technique for recognizing and managing information of print apparatuses connected on the network so as to manage them has been developed.

However, an existing management system such as UPnP and the like is a technical specification required to connect the print apparatus and computer, but it merely specifies a protocol and data format required to make devices communicate with each other.

Therefore, even when information managed by a management system such as UPnP or the like is used, a problem, e.g., a requirement of complicated settings, remains unsolved so as to install a control program such as a device driver or the like for controlling the print apparatus in the computer.

When a plurality of management methods that manage network compatible print apparatuses are present together, a management system that supports a specific management method cannot recognize another print apparatus on the network, which does not support the specific management method.

In order to meet requirements for users and markets of various countries, a large variety of rendering language systems for print apparatuses have been developed and brought out to the markets. Expenses for the development of print apparatuses for respective rendering language systems from the beginning are high. In order to reduce such cost, print apparatuses in which a part depending on each rendering language system is separated as an option board or software and the option board or software can be mounted again in the print apparatus in accordance with the user requirements or market requirements of various countries have become available.

In addition, for an environment in which a plurality of rendering language systems appreciated by the users are present, print apparatuses each of which supports a plurality of rendering language systems are also available.

The aforementioned print apparatuses whose rendering language systems can be changed by means of option boards or software or print apparatuses that support a plurality of rendering language systems are not assumed upon mounting the Plug and Play function.

Since the Plug and Play function is introduced to reduce the load on the user's complicated installation process, a user interface that can obviate the need for selection process that confuses the users who are not used to operation of the print apparatus such as selection of a PDL from a plurality of rendering language systems for a detected print apparatus is demanded.

For the above two reasons, the Plug and Play function installed on a given OS searches the information processing apparatus for a printer driver corresponding to a print apparatus on the basis of only the vendor name and printer name of identification data (DeviceID) of the print apparatus passed from it to the information processing apparatus by ignoring information indicating a rendering language system, and installs the printer driver detected first.

The Plug and Play function described above suffers the following drawbacks.

First, for example, assume two rendering language systems (printer language interpreters; PDL1, PDL2) can be mounted on a print apparatus which can switch support rendering language systems by mounting an option board in it, and only PDL1 is actually mounted on the print apparatus. Also, assume printer drivers for these languages have already been stored in the information processing apparatus. In this case, the Plug and Play function searches the information processing apparatus for a printer driver corresponding to that print apparatus using only the vendor name and printer name of the identification information of the print apparatus passed from the print apparatus to the information processing apparatus by ignoring information indicating a rendering language system. If the Plug and Play function detects a printer driver for PDL2 first, it installs PDL2 for this print apparatus on the OS. The option board that processes the rendering language system for PDL1 does not recognize PDL2, resulting in a print error.

Second, in case of a print apparatus that can support a plurality of rendering language systems, the Plug and Play function detects a printer driver of a rendering language system for an emulation which is not recommended by the vendor first, and other efficient rendering systems are not used.

### DISCLOSURE OF THE INVENTION

It is an object of the present invention to provide a technique for making other devices on a network recognize a device that does not support the network compatible Plug and Play function as a device that supports the network compatible Plug and Play function, and making that device serve as the device with the function.

In order to achieve this object, for example, a network device management apparatus according to the present invention comprises the following arrangement. That is, there is provided a network device management apparatus which has network connection means and manages a network device which is connected to a network, the device having a plurality of functions, comprising:

storage means for storing a network address of at least one network device that does not support any network compatible Plug and Play function, and function information associated with a plurality of functions of the network device; and

response means for, when a location confirmation request of a network compatible Plug and Play device is received via the network connection means, generating and returning a message including identification information which specifies the network device that does not support the network compatible Plug and Play function as a plurality of independent virtual network compatible Plug and Play devices corresponding to the functions indicated by the plurality of pieces of function information stored in the storage means.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram showing the software configurations of respective devices that form a network system according to an embodiment of the present invention;

FIG. 2 is a flowchart showing the processing sequence of a proxy server in the embodiment of the present invention;

FIG. 3 is a flowchart showing a UPnP compatible print apparatus search process;

FIG. 4 shows an example of a Probe packet;

FIG. 5 shows an example of a ProbeMatch packet as a response packet of the Probe packet;

FIG. 6 is a flowchart showing a print apparatus information acquisition process;

FIG. 7 shows the format of a management table;

FIG. 8 is a flowchart showing a protocol conversion process;

FIG. 9 shows an example of a Request packet of PrinterDescription;

FIG. 10 shows an example of a Response packet of PrinterDescription;

FIG. 11 is a block diagram showing the hardware arrangement of a client and proxy server according to the embodiment of the present invention; and

FIG. 12 is a block diagram showing the hardware arrangement of printers 200 and 400 according to the embodiment of the present invention.

### BEST MODE FOR CARRYING OUT THE INVENTION

Preferred embodiments of the present invention will be described hereinafter with reference to the accompanying drawings.

A protocol conversion system as an embodiment of a service providing system according to the present invention will be described below.

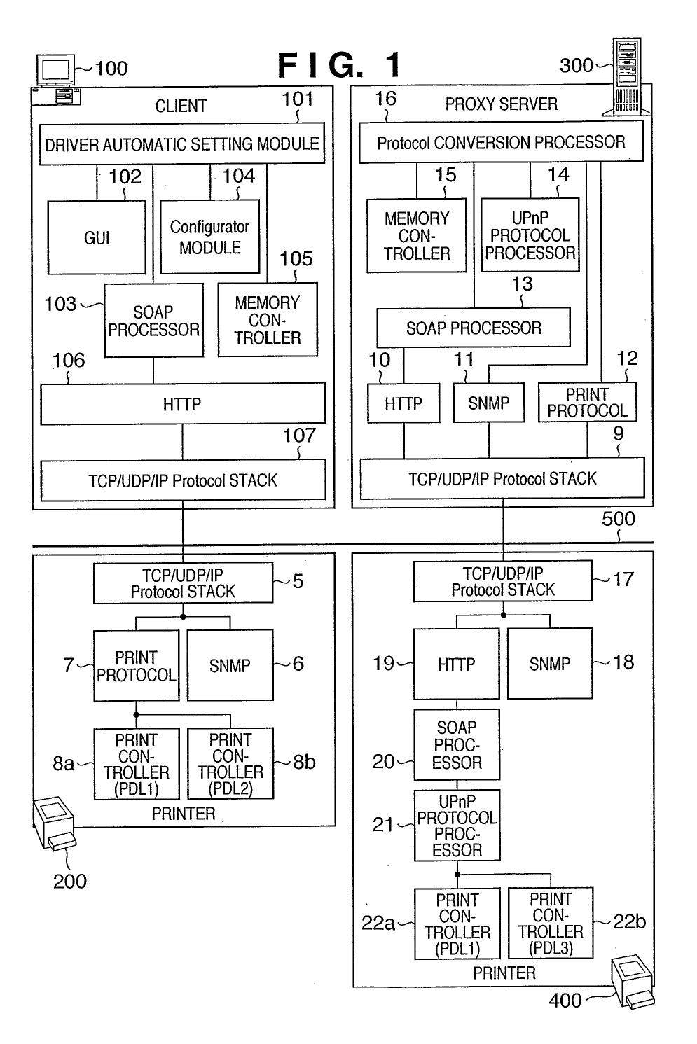

FIG. 1 is a block diagram showing the software configuration of a print system as an embodiment of the present invention.

On a client 100, a general-purpose operating system such as Windows® as an OS provided by Microsoft Corporation, Mac OS® provided by Apple Computer, Inc., or the like, and general-purpose applications that run on such OS are installed.

The general-purpose operating system comprises a TCP/UDP/IP protocol stack 107 as a communication function, and an HTTP 106 on that protocol stack, so as to perform interpretation and response processes of HTTP requests. The general-purpose operating system comprises, on the HTTP 106, a Simple Object Access Protocol (SOAP) processor 103 which forms a communication means associated with UPnP. A driver automatic download/setting module 101 uses the aforementioned communication means so as to communicate with UPnP compatible print apparatuses and a proxy response device to be described in this embodiment on the network.

The driver automatic download/setting module 101 uses a GUI 102 so as to display print apparatuses detected by UPnP on the client 100 and prompt the user to select.

A configurator module 104 registers (installs) a corresponding printer driver on the OS from those stored in a hard disk on the basis of information acquired from the print apparatus via the network.

Upon installation, management control of the presence/absence of a memory space and an installation destination is executed via a memory controller 105. The memory controller 105 controls a hard disk drive (which stores the OS, various applications, the aforementioned software modules, and data files created by the applications).

On the other hand, in this embodiment, a network compatible print apparatus 200 comprises a TCP/UDP/IP protocol stack 5 as a communication function, and a Simple Network Management Protocol (SNMP) processor 6 on that protocol stack. A print protocol processor 7 is mounted on the protocol stack 5 and has a function of interpreting a print request issued by the client and outputting that print request to a print controller 8. Note that the print apparatus 200 can have print controllers 8 for a plurality of PDLs at the same time. Also, the print controller 8 may be detachably designed, and may be replaced according to a user's request, thus changing the PDL supported by the print apparatus 200. In this embodiment, assume that the print apparatus 200 stores print controllers 8a and 8b for two PDLs, i.e., PDL1 and PDL2. This print apparatus does not comprise any UPnP protocol processor, and cannot respond to a device search request and UPnP print job request using the UPnP protocol issued by the client 100 by itself.

Another network compatible device, i.e., a network compatible print apparatus 400 in this embodiment comprises a TCP/UDP/IP protocol stack 17 as a communication function, and an HTTP 19 on that protocol stack, so as to perform interpretation and response processes of HTTP requests.

The print apparatus 400 comprises a Simple Network Management Protocol (SNMP) 18 on that protocol stack as in the print apparatus 200.

The print apparatus 400 comprises a Simple Object Access Protocol (SOAP) processor 20 and UPnP protocol processor 21 as upper layers of the HTTP 19. The network compatible print apparatus 400 has a PrintBasic service designated by the UPnP Forum, and the UPnP protocol processor has a function of interpreting a print job and its property information defined by that service and outputting that print request to a print controller 22. The print apparatus 400 can comprise print controllers 22 for a plurality of PDLs at the same time. Also, the print controller 22 may be detachably designed, and may be replaced according to a user's request, thus changing the PDL supported by the print apparatus 400. In this embodiment, assume that the print apparatus 400 stores print controllers 22a and 22b for two PDLs, i.e., PDL1 and PDL3.

Likewise, a proxy server 300 that serves as a network management apparatus as a characteristic feature of this embodiment comprises a TCP/UDP/IP protocol stack 9 as a communication function, and an HTTP 10 on that protocol stack to perform interpretation and response processes of HTTP requests.

The proxy server 300 comprises a Simple Network Management Protocol (SNMP) processor 11 on the protocol stack 9, and implements by this protocol a search process of the network compatible print apparatus 200 which does not comprise any UPnP protocol processor, and an acquisition process of information.

The proxy server 300 comprises a Print Protocol processor 12 on the protocol stack 9. The Print Protocol processor 12 issues a print job to the network compatible print apparatus 200 which does not comprise any UPnP protocol processor.

The proxy server 300 comprises a Simple Object Access Protocol (SOAP) processor as an upper layer of the HTTP 10. When a plurality of clients 100 and proxy servers 300 are present on the network, a UPnP protocol processor 14 and protocol conversion processor 16 implement two-way communications of data described in eXtensible Markup Language (XML) via the processor 13.

The protocol conversion processor 16 is located as an upper layer of the SNMP processor 11, SOAP processor 13, UPnP processor 14, print protocol processor 12, and memory controller 15. The protocol conversion processor 16 records information of the network compatible print apparatus acquired via the SNMP processor 11 on a memory controlled by the memory controller 15 after it creates various XML documents used by the UPnP protocol. Also, upon reception of a request from the UPnP protocol, the protocol conversion processor 16 reads out an XML document recorded on the corresponding management table, and transmits it to the UPnP processor 14.

Upon reception of a print job request by the UPnP protocol, the protocol conversion processor 16 acquires a job command and job property information via the SOAP processor 14, converts the contents into a print protocol supported by the output-designated print apparatus, and transmits it to the designated print apparatus via the print protocol processor 12.

The protocol conversion processor 16 executes a read/write process of a management table managed by the proxy server 300 on a memory controlled by the memory controller 15 via that controller 15. Likewise, when the protocol conversion processor 16 acquires a management table managed by another proxy server present on the network, it performs a read/write process of that management table managed by the proxy server 300 on a memory controlled by the memory controller 15 via that controller 15.

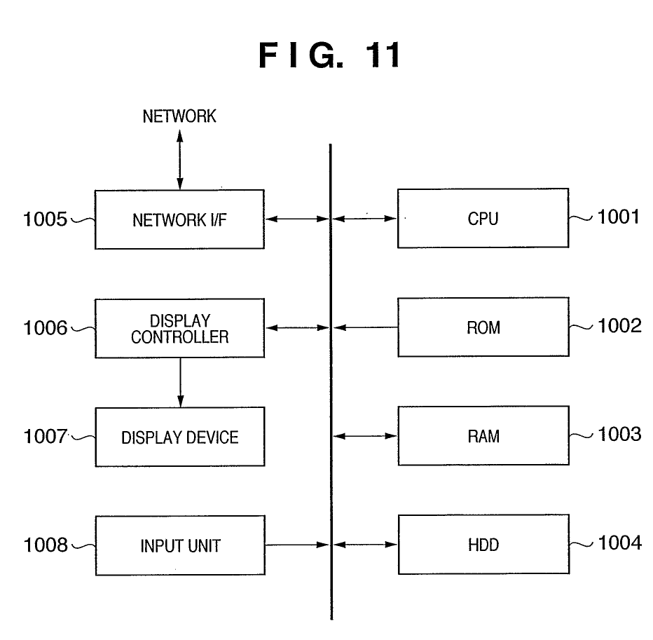

The configurations of computer programs which are mounted in association with the print processes of the respective apparatus have been described. The client 100 and proxy server 300 can be implemented by a general-purpose information processing apparatus such as a personal computer or the like. The hardware arrangement is as shown in, e.g., FIG. 11.

Referring to FIG. 11, reference numeral 1001 denotes a CPU which controls the overall apparatus; and 1002, a ROM which stores a BIOS and boot program. Reference numeral 1003 denotes a RAM which is used as a work area of the CPU 1001. Reference numeral 1004 denotes a hard disk drive which stores an OS, applications and various programs, data files, and the like. Reference numeral 1005 denotes a network interface. In this embodiment, the network interface 1005 comprises an Ethernet® card, but it may comprise a wireless LAN card instead. Reference numeral 1006 denotes a display controller, which incorporates a video memory, and a video controller that makes rendering under the control of the CPU 1001, and outputs image data stored in the video memory as a video signal. Reference numeral 1007 denotes a display device, which is represented by a liquid crystal display or CRT. Reference numeral 1008 denotes an input device such as a keyboard, mouse, and the like.

In the above arrangement, when the power switch of the apparatus is turned on, the CPU 1001 loads the OS from the hard disk 1004 onto the RAM 1002 in accordance with the boot program of the ROM 1002, and then loads various device drivers. If the apparatus shown in FIG. 11 is the client 100, the CPU 1001 loads and executes a program corresponding to the configuration shown in FIG. 1. In case of the proxy server 300, after the OS is loaded, the CPU 1001 loads a program corresponding to the configuration shown in FIG. 1, and executes processes to be described later.

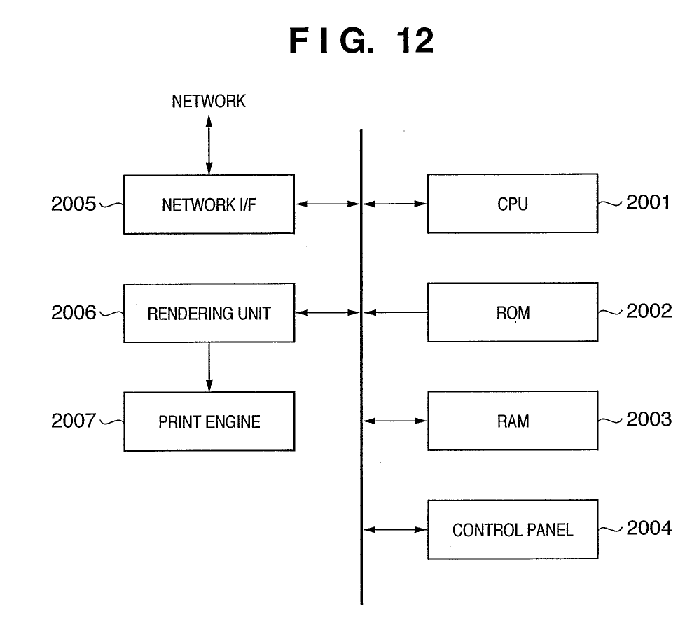

FIG. 12 is a block diagram of a network printer. Referring to FIG. 12, reference numeral 2001 denotes a CPU which controls the overall printer; and 2002, a ROM which stores a print process program to be executed by the CPU 2001, and font data. Reference numeral 2003 denotes a RAM which is used as a work area of the CPU 2001, reception buffer, and image rendering area; and 2004, a control panel which includes various switches and buttons, and a liquid crystal display unit used to display messages. Reference numeral 2005 denotes a network interface used to connect the network; 2006, a rendering unit; and 2007, a printer engine that actually prints on a print sheet.

The print apparatuses 200 and 400 shown in FIG. 1 have the hardware arrangement shown in FIG. 12 when they are seen in broad perspective. The difference between the configurations of the print apparatuses 200 and 400 shown in FIG. 1 is a difference in firmware stored in the ROM 2002, or a difference in various option boards in some cases.

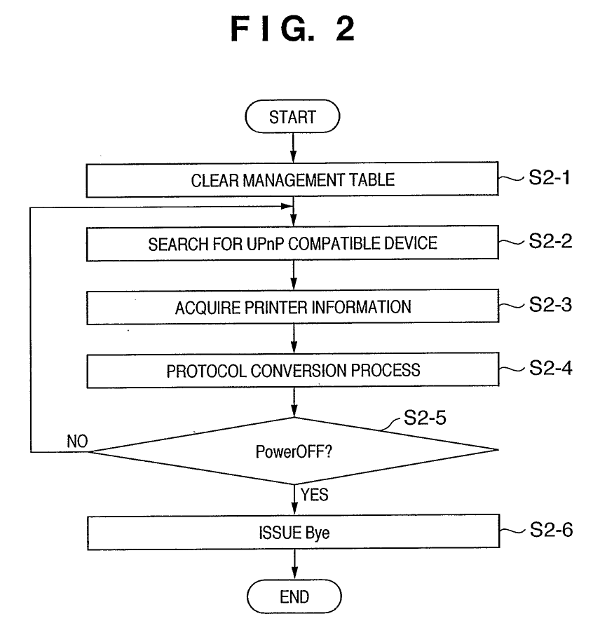

The flow of the control of the system in the embodiment with the above arrangement will be described below with reference to the flowchart shown in FIG. 2.

FIG. 2 is a flowchart showing the processing sequence of the proxy server 300 in this embodiment. The processing shown in this flowchart corresponds to a server application which is loaded from the hard disk 1004 onto the RAM 1003 and is executed after the power switch of the proxy server 300 is turned on and the OS is launched.

The protocol conversion processor 16 of the proxy server 300 clears the contents of a management table which is assured in the hard disk 1004 in advance and records network device information to which the protocol conversion process is applied, after it is launched (step S2-1). Details of the management table will be explained in the following process.

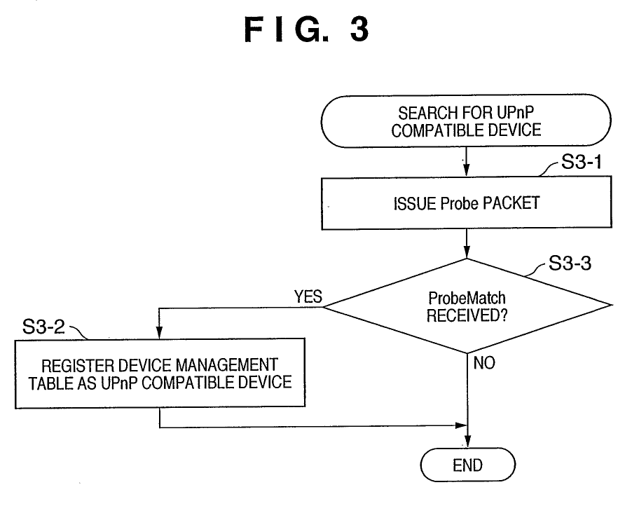

Upon logging onto the network to start a service, a UPnP compatible print apparatus present on the network is searched (step S2-2). This search process is shown in FIG. 3, and will be described below.

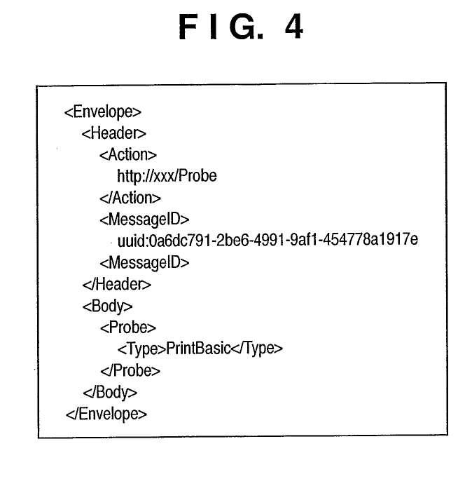

In step S3-1, the proxy server issues a Probe packet with the format shown in FIG. 4, which is specified by UPnP, to the multicast address. That is, the proxy server logs onto the network and transmits a message used to acquire the locations of UPnP compatible network devices. Note that uuid (Universally Unique Identifier) in the packet message in FIG. 4 is an identifier unique to a UPnP device, and indicates as if the proxy server 300 were functioning as a UPnP device (uuid is set and held in advance).

The protocol conversion processor 16 of the proxy server 300 interprets all responses from the network within a prescribed period of time after it issues the Probe packet shown in FIG. 4.

In this embodiment, since the print apparatus 400 on a network 500 is a UPnP compatible print apparatus, it returns a response message to the Probe packet from the proxy server 300 to the proxy server. However, the print apparatus 200 does not respond since it is non-UPnP device.

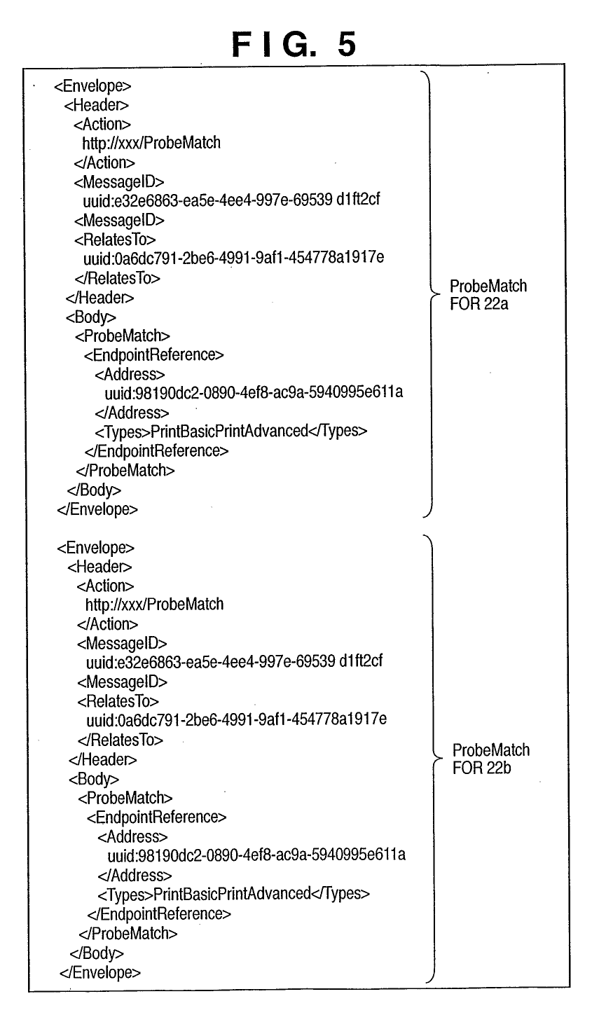

FIG. 5 shows an example of ProbeMatch as a response packet from the UPnP compatible print apparatus 400 as an example of a network device. The protocol conversion processor 16 of the proxy server 300 records and saves a URL to the network print apparatus (UPnP compatible print apparatus 400) which passed this packet in a memory (hard disk in this embodiment) controlled by the memory controller 15 via that controller. This process is executed for all received response packets, and the proxy server 300 records URLs of all UPnP compatible print apparatus present on the network (step S3-2).

Upon completion of the aforementioned process, if no response is detected in step S3-3, the protocol conversion processor 16 of the proxy server 300 ends the UPnP search process, and the flow advances to step S2-3 in FIG. 2 to start an acquisition process of print apparatus information.

Note that the UPnP compatible print apparatus returns one response with the ProbeMatch format per PDL supported by that print apparatus in response to the Probe packet. As shown in FIG. 5, the UPnP compatible print apparatus 400 issues two ProbeMatch packets having the same URL for the print controllers 22a and 22b. Each ProbeMatch packet has a unique uuid in an <Address> tag so as to uniquely designate each service.

In the example of FIG. 5, the uuid for PDL1 is uuid:98190dc2-0890-4ef8-ac9a-5940995e661a, and that for PDL3 is uuid:98190dc2-0890-4ef8-ac9a-5940995e661b.

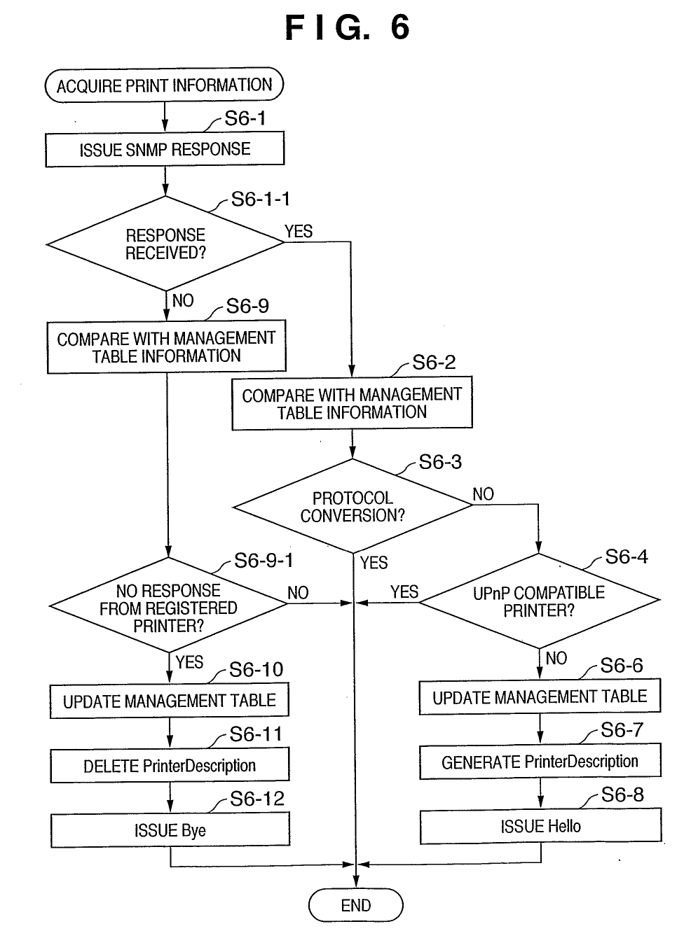

FIG. 6 is a flowchart showing details of the print apparatus information acquisition process in step S2-3 in FIG. 2.

The protocol conversion processor 16 of the proxy server 300 broadcasts an SNMP Get request from the SNMP control module (processor) 11 to the following MIB object, thus acquiring print apparatus information present on the network (step S6-1).

PrinterMakeAndModel: print apparatus vendor/product name

PrinterName: print apparatus name

PrinterLocation: print apparatus location

IPAddress: print apparatus IP address

MACAddress: print apparatus MAC address

SupportedPDL: supported page description language

SupportedPrintProtocol: supported print protocol

Upon reception of the above SNMP Get request, each of the print apparatuses 200 and 400 as network devices generates information corresponding to each object using the SNMP processor 6 or SNMP processor 18 of the print apparatus, and unicasts a response packet (response message) to the proxy server 300 as an SNMP response.

It is checked in step S6-1-1 if a response is received. If it is determined that a response is received, the flow advances to step S6-2; otherwise, the flow advances to step S6-9.

The protocol conversion processor 16 of the proxy server 300 that receives the response from each network compatible print apparatus compares the response contents with the contents of a print apparatus management table that has already been registered in the memory (step S6-2) to check if the print apparatus has already undergone protocol conversion (step S6-3). This checking process is attained by collating the uuid or IP address.

It is checked in step S6-3 if the print apparatus has not undergone protocol conversion, i.e., a new print apparatus is found. If a new print apparatus is found, the protocol conversion processor 16 of the proxy server 300 checks by comparing the URL of the UPnP compatible print apparatus previously recorded on the memory if that print apparatus is compatible to UPnP (step S6-4).

That is, if the print apparatus IP address acquired as a response to the SNMP Get request matches the URL recorded on the memory, i.e., if the print apparatus returns a response in the search process in step S2-2 in FIG. 2, and also returns a response in step S6-1, it is determined that the print apparatus of interest is a UPnP compatible print apparatus, and no protocol conversion is applied to that print apparatus. That is, that print apparatus is not registered in the management table.

In other words, if the print apparatus does not return any response in the search process in step S2-2 in FIG. 2 but returns a response in step S6-1, it is determined that the print apparatus of interest is a non-UPnP print apparatus. In this case, the flow advances to step S6-6 to additionally register that print apparatus in the management table assured on the hard disk via the memory controller 15.

In this case, according to this embodiment, if a search is conducted using the print apparatus vendor/product name in the information acquired as the response to the SNMP Get request, and if that print apparatus is a model that can mount print controllers of a plurality of languages or supports detachable print controllers, the supported PDL is confirmed based on the SupportedPDL, and a PrinterDescription element is added to the management table in correspondence with the controller that supports each individual PDL as a logically independent print apparatus, so as to define it as a UPnP compatible print apparatus.

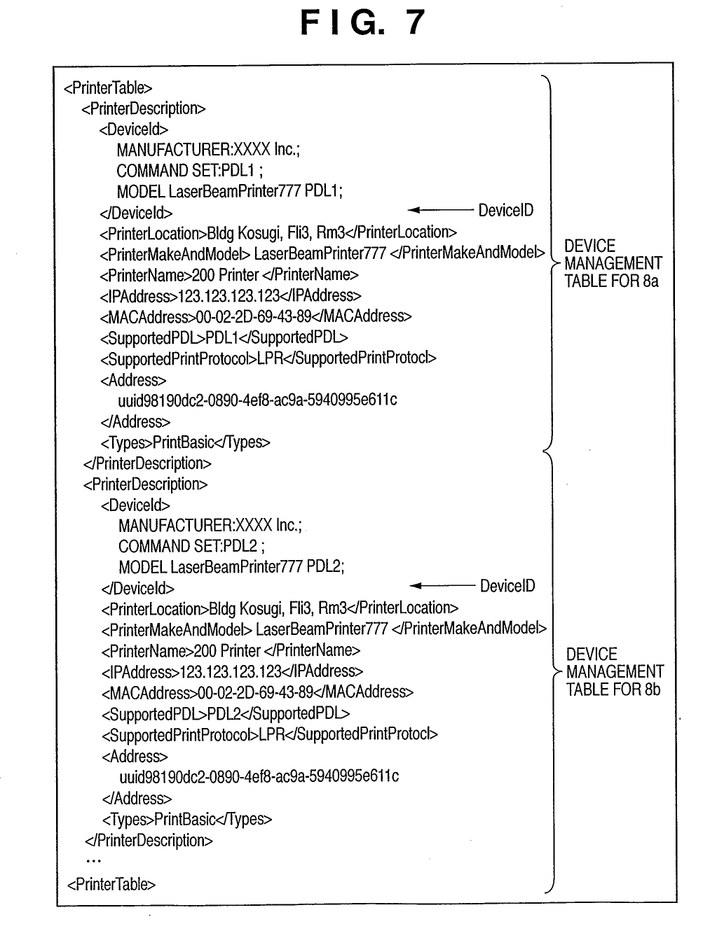

In the system arrangement of this embodiment, the print apparatus 200 is a non-UPnP print apparatus, and two PrinterDescription elements are added to the print apparatus management table in correspondence with the print controllers 8a and 8b as logically independent print apparatuses, as shown in FIG. 7. The proxy server 300 outputs the information shown in FIG. 7 onto the network in response to a Probe packet or predetermined search packet from the client. The packet shown in FIG. 7 is received by the client side separately as the device ID for the print controller 8a and that for the print controller 8b, or together in a format that can be recognized as independent device IDs. Then, Plug and Play processes are executed for respective device IDs. That is, when the installer on the client side acquires the device ID for the print controller 8a, it installs PDL1; when the installer on the client side acquires the device ID for the print controller 8b, it installs a driver for another PDL2. When the client issues a device search request, the print apparatus 200 is displayed not as one device but as a plurality of logical devices. Which printer driver is to be installed is determined in advance by referring to a database indicating information sets that indicate the device IDs and driver storage locations on the client side. For example, when the installer on the client side recognizes a set of MANUFACTURED and MODEL in the device ID field for the print controller 8a, which is acquired by the client from the proxy server 300, it refers to the database using the set of MANUFACTURED and MODEL for the print controller 8a to recognize the storage location of the printer driver, and installs that driver. Alternatively, the installer may recognize all sets of MANUFACTURED, COMMAND, and MODEL in the device ID field for the print controller 8a, and may automatically recognize and install a device driver for PDL1 from a plurality of device drivers corresponding to MANUFACTURED and MODEL.

As DeviceID in the PrinterDescription element, the protocol conversion processor 16 registers device IDs (in FIG. 7, two IDs, i.e., “LaserBeamPrinter777 PDL1” and “LaserBeamPririter777 PDL2”), which can uniquely designate printer drivers corresponding to PDLs stored in the client 100, in the corresponding PrinterDescription elements. Also, the protocol conversion processor 16 registers respective logical print apparatuses to have different uuid values in the <Address> tags so that these logical print apparatuses can be designated using UPnP packets.

The aforementioned information is recorded on the hard disk via the memory controller 15 (step S6-7). In step S6-8, the UPnP protocol processor 14 issues Hello packets associated with all the print apparatuses recorded in the management table to inform devices on the network as if the two UPnP print apparatuses (two virtual UPnP print apparatuses) were starting their services.

On the other hand, if no response is obtained in response to the SNMP Get request issued by the proxy server 300, i.e., if NO is determined in step S6-1-1, the flow advances to step S6-9 to search the management table and to confirm already registered print apparatuses.

It is checked if the already registered print apparatuses do not return any response (step S6-9-1). If the already registered print apparatuses do not return any response, it indicates that the power switch of each print apparatus is turned off or that print apparatus logs out the network. In this case, the flow advances to step S6-10, and the protocol conversion processor 16 of the proxy server 300 updates the management table by deleting the information of the corresponding print apparatuses from the management table. In step S6-11, the protocol conversion processor 16 deletes the PrinterDescription elements of the corresponding print apparatuses.

The protocol conversion processor 16 of the proxy server 300 issues Bye packets associated with all print apparatuses deleted from the management table using the UPnP protocol processor 14, thus informing that these print apparatuses deleted from the management table stop their services on the network (step S6-12).

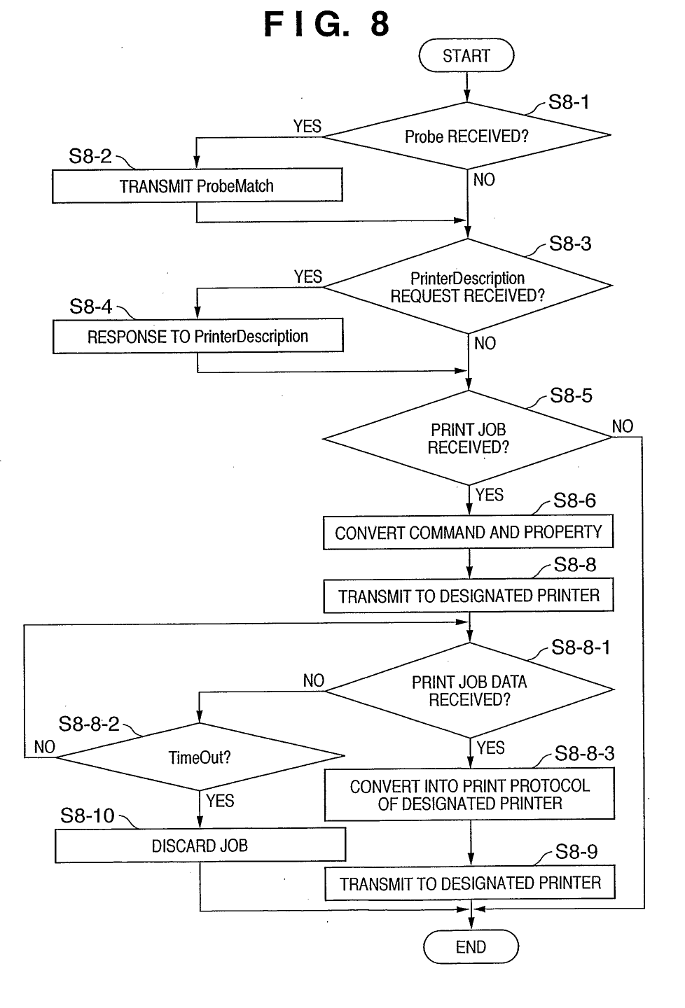

Details of the protocol conversion process (step S2-5) in FIG. 2 will be described below with reference to the flowchart of FIG. 8.

The protocol conversion processor 16 of the proxy server 300 checks if it receives a reception message of a device search protocol Probe packet issued by the client on the network from the UPnP protocol processor 14 (step S8-1). That is, it is determined if the client is searching for UPnP network devices.

If it is determined that the Probe packet is received, the flow advances to step S8-2, and the print apparatus management table shown in FIG. 7, which is managed on the hard disk by the protocol conversion processor 16 of the proxy server 300, is searched via the memory controller 15. If a print apparatus that matches the search condition of the Probe packet is registered in the management table, a ProbeMatch packet is generated from the print apparatus management table, and is returned via the UPnP protocol processor 14.

The ProbeMatch packet has the structure shown in FIG. 5, and one packet is issued for each print controller that matches the search condition of the Probe packet. The ProbeMatch packet has a unique uuid in its <Address> tag to be able to uniquely designate a logical print apparatus associated with that PDL. The proxy server 300 of this embodiment returns the ProbeMatch packets for all the corresponding print apparatuses registered on the management table.

As a result, the client that transmitted the above Probe packet can see the proxy server 300 as the UPnP print apparatus (two UPnP print apparatuses since the print apparatus 200 has controllers of two languages in this embodiment).

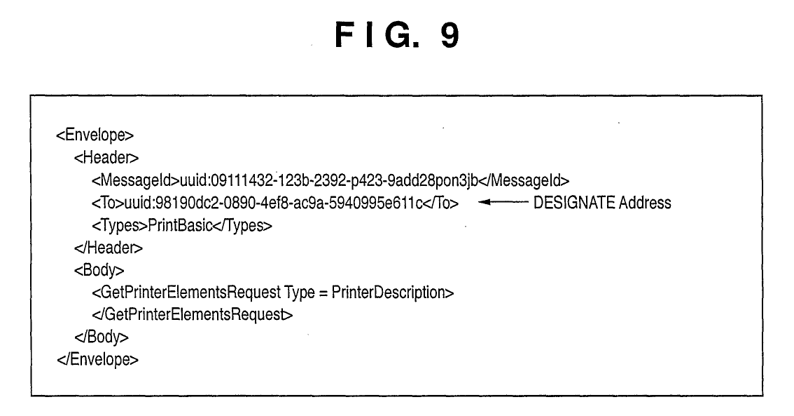

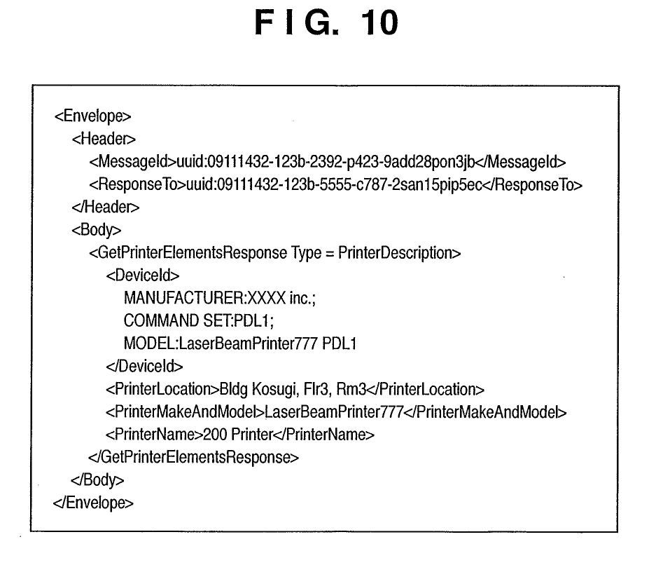

After the flow advances to step S8-3, it is checked if the UPnP protocol processor 14 receives a PrinterDescriptionRequest packet shown in FIG. 9. Upon reception of this packet, the proxy server 300 searches for the <Address> tag of the print apparatus management table managed by the protocol conversion processor 16 using uuid indicated by a <To> tag in the PrinterDescription acquisition request, and generates a PrinterDescriptionResponse packet shown in FIG. 10 from the print apparatus management table. The generated PrinterDescriptionResponse packet is returned to the request source via the UPnP protocol processor 14 (step S8-4).

It is checked in step S8-5 if a UPnP print job request is received from the client device that acquired the PrinterDescriptionResponse packet. Since a job command and job property of this request are described in XML, the print apparatus 200 as a non-UPnP device cannot interpret them intact. Hence, if the protocol processor 16 of the proxy server 300 receives such print job via the UPnP protocol processor 14 (YES in step S8-5), it interprets the command and job property using the SOAP processor, acquires the supported print protocol (a protocol described between <SupportedPrintProtocol> and </SupportedPrintProtocol> in FIG. 7, and is “LPR” in FIG. 7) and IP address of the management table information corresponding to the output-designated print apparatus via the memory controller 15, and converts the received command and property information into the acquired print protocol (step S8-6). Then, the converted information is transmitted to the IP address of the output-designated print apparatus (step S8-8).

Since the print job from the client includes uuid (it is also uuid created by the proxy server 300 for the print apparatus 300) of the print apparatus which is to execute the print process, the IP address of the print apparatus can be acquired using this information as a key.

The client that issued the print job subsequently transmits job data (in this case, PDL data) to the proxy server 300 using an HTTP POST command. It is checked in step S8-8-1 if this job data is received.

This checking process is done until it is determined in step S8-8-2 that a predetermined period of time has elapsed. If no job data is received after an elapse of the predetermined period of time, that job request is discarded in step S8-10. At this time, a discard request is also issued to the designated print apparatus.

If the job data is received within the predetermined period of time after reception of the print job request, the protocol conversion processor 16 of the proxy server 300 converts the received job data into the print protocol supported by the designated print apparatus as in the aforementioned step (step S8-8-3), and transmits the job data to the previously acquired print apparatus IP address (step S8-9).

As a result, the print apparatus that received the job command, job property, and job data interprets the job command and job property using the print protocol processor, and transmits the print job to the corresponding print controller, thus executing a print process.

As can be seen from FIG. 2, the proxy server 300 repeats the aforementioned processes, i.e., steps S2-2 to S2-4 to periodically update the operation states of the network print apparatus, and executes protocol conversion processes according to the updated information unless it receives a power OFF instruction.

If it is determined in FIG. 2 that the power OFF instruction of the proxy server 300 is received, the flow advances from step S2-5 to step S2-6. In this case, in order to stop the protocol conversion processes, the protocol conversion processor 16 of the proxy server 300 reads out all management tables via the memory controller 15, and issues Bye packets (UPnP network logout message) for all print apparatuses recorded in the management tables via the UPnP protocol processor 14, thereby informing other devices (clients) on the network that these print apparatuses stop their services on the network.

As described above, according to this embodiment, the proxy server 300 detects and registers a non-UPnP print apparatus (printer) on the network using the SNMP protocol. In place of that non-UPnP printer, the proxy server 300 behaves as if it were a UPnP print apparatus. Upon reception of a print job, the proxy server 300 outputs the print job to the designated non-UPnP print apparatus. As a result, the non-UPnP print apparatus serves as a member of the UPnP network.

Note that the proxy server 300 of this embodiment has been explained as a server that substitutes for a non-UPnP network print apparatus. However, the object to be substituted is not limited to the print apparatuses but may be other devices. As network compatible devices other than printers, a storage device such as a hard disk or the like, a scanner, a copying machine, and a device with these functions together may be used as long as they can exchange property information and jobs with the proxy server via the communication function. In this case, as a communication protocol between the proxy server and network compatible device, a standardized or general-purpose protocol or a protocol unique to a vendor may be similarly used.

In this embodiment, the embodiment using network compatible devices as an example has been explained. A communication between the devices and proxy server may be implemented by that of local connections such as USB, IEEE1394, parallel, or the like, and a network is not limited to a wired or wireless communication.

In this embodiment, the proxy server is independently present on the network. However, the proxy server function may be physically or locally incorporated in a network compatible device.

Furthermore, as a combination of protocol conversion to be provided by the proxy server of this embodiment, Universal Plug and Play mainly designed by Microsoft Corporation, SNMP of a network compatible print apparatus, and print protocol have been exemplified. However, the present invention can be applied to protocols such as Rendezvous proposed by Apple Computer, Inc., BMLinkS proposed by JBMIA, and the like. Also, the present invention can be applied not only to protocols that integrate device search and control processes but also to protocols such as Service Location Protocol (SLP), Multicast DNS Service Discovery, and the like, which are used to search for services provided by devices, and conversion of device control in the Remote Procedure Call (RPC) format based on XML/SOAP into the conventional control protocol (e.g., Web Service).

In this embodiment, as an information protocol with the proxy server, the HTTP/TCP/UDP/IP protocol is used. However, the present invention does not depend on any transport means, and another general-purpose protocol or unique protocol may be used as long as two-way communications can be made.

As described above, a proxy response apparatus is provided to a print apparatus which does not support network compatible Plug and Play, and when the model name of a device ID acquired by a protocol supported by the print apparatus other than network compatible Plug and Play has no PDL name property, a response of a peripheral device search protocol of network compatible Plug and Play is returned by appending the PDL name to the model name, thus automatically installing an appropriate printer driver in the information processing apparatus.

The proxy response apparatus is provided to a print apparatus which does not support network compatible Plug and Play, and when the device ID acquired by a protocol supported by the print apparatus other than network compatible Plug and Play supports a plurality of PDLs, responses to a peripheral device search protocol of network compatible Plug and Play are made to include device IDs obtained by appending respective PDL names to the model name of the device ID, so that the print apparatus is recognized as logical print apparatuses corresponding in number to the PDLs. Hence, the information processing apparatus can recognize other logical entities.

As described above, according to the present invention, the network device management apparatus of the present invention substitutes for a device which does not support network compatible Plug and Play and is present on the network, can make other devices on the network virtually recognize that device as a device which supports network compatible Plug and Play, and can make that device serve as a device with the function.

As has been described in the above embodiment, principal part of this embodiment lies in the processing of the proxy server 300. The proxy server 300 requires a storage device such as a hard disk or the like, as described above, but it is implemented by a server application program that runs on a general-purpose information processing apparatus such as a personal computer or the like. Hence, the present invention includes a computer program within its scope. Normally, since the computer program can be copied to or installed in a system by setting a computer-readable storage medium such as a CD-ROM in a computer, such computer-readable storage medium is included in the scope of the present invention.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-123443 filed on Apr. 19, 2004, the entire contents of which are hereby incorporated by reference herein.

1.-11. (canceled)

12. A network device management apparatus which has network connection means and manages a network device which is connected to a network, said device having a plurality of functions, comprising:
storage means for storing a network address of at least one network device that does not support any network-compatible Plug and Play function, and function information associated with a plurality of functions of the network device; and
response means for, when a location confirmation request of a network-compatible Plug and Play device is received via the network connection means, generating and returning a message including identification information which specifies the network device that does not support the network-compatible Plug and Play function as a plurality of independent virtual network-compatible Plug and Play devices corresponding to the functions indicated by the plurality of pieces of function information stored in said storage means,
wherein the identification information identifying the plurality of independent virtual network-compatible Plug and Play devices is used for installing a plurality of device drivers corresponding to the plurality of independent virtual network-compatible Plug and Play devices.

13. The apparatus according to claim 12, wherein the function information stored in said storage means includes protocol information required to communicate with a network device to be stored.

14. The apparatus according to claim 13, further comprising control means for, when job information addressed to the virtual network-compatible Plug and Play device is received via the network connection means, acquiring an address and protocol information of the corresponding network device from said storage means, converting the job information into the acquired protocol, and transmitting the converted information to the acquired address.

15. The apparatus according to claim 12, wherein the functions indicated by the function information include functions of a plurality of different printer drivers that can generate print data which can be processed by the network device.

16. The apparatus according to claim 12, further comprising:
search means for searching for a network device which does not support any network-compatible Plug and Play function;
registration means for registering in said storage means a network address of a network device found by said search means, and information for specifying a protocol used in a communication with the network device found by said search means; and
generation means for generating a message to be returned by said response means in place of the registered network device.

17. The apparatus according to claim 16, wherein said search means determines, as a network device group that does not support any network-compatible Plug and Play function, a network device group which remains after excluding network devices detected as a search result of a UPnP network protocol from a network device group detected by a search of an SNMP protocol.

18. The apparatus according to claim 12, wherein the network device is a network printer.

19. The apparatus according to claim 18, wherein, when the network device supports a plurality of printer languages, said response means responds as a logically virtual network-compatible Plug and Play printer which is independent for each individual printer language.

20. A method of controlling a network device management apparatus which has network connection means, and storage means for storing a network address of at least one network device that does not support any network-compatible Plug and Play function, and protocol information used to communicate with the network device, and manages a network device connected to a network, said method comprising the step of:
generating and returning, when a location confirmation request of a network-compatible Plug and Play device is received via the network connection means, a message including identification information which specifies the network device that does not support the network-compatible Plug and Play function as a plurality of independent virtual network-compatible Plug and Play devices corresponding to the functions indicated by a plurality of pieces of function information stored in the storage means,
wherein the identification information identifying the plurality of independent virtual network-compatible Plug and Play devices is used for installing a plurality of device drivers corresponding to the plurality of independent virtual network-compatible Plug and Play devices.

21. A computer program, stored in a computer-readable storage medium, serving as a network device management apparatus which has network connection means, and storage means for storing a network address of at least one network device that does not support any network-compatible Plug and Play function, and protocol information used to communicate with the network device, and manages a network device connected to a network, said program comprising code for performing the step of:
generating and returning, when a location confirmation request of a network-compatible Plug and Play device is received via the network connection means, a message including identification information which specifies the network device that does not support the network-compatible Plug and Play function as a plurality of independent virtual network-compatible Plug and Play devices corresponding to the functions indicated by a plurality of pieces of function information stored in the storage means,
wherein the identification information identifying the plurality of independent virtual network-compatible Plug and Play devices is used for installing a plurality of device drivers corresponding to the plurality of independent virtual network-compatible Plug and Play devices.

22. A computer-readable storage medium storing the computer program of claim 21.

23. The method according to claim 20, wherein the function information stored in the storage means includes protocol information required to communicate with a network device to be stored.

24. The method according to claim 23, further comprising a control step of, when job information addressed to the virtual network-compatible Plug and Play device is received via the network connection means, acquiring an address and protocol information of the corresponding network device from said storage means, converting the job information into the acquired protocol, and transmitting the converted information to the acquired address.

25. The method according to claim 20, wherein the functions indicated by the function information include functions of a plurality of different printer drivers that can generate print data which can be processed by the network device.

26. The method according to claim 20, further comprising:
a search step of searching for a network device which does not support any network-compatible Plug and Play function;
a registration step of registering in the storage means a network address of a network device found in said search step, and information for specifying a protocol used in a communication with the network device found in said search step; and
a generation step of generating a message to be returned in said step of generating and returning in place of the registered network device.

27. The method according to claim 26, wherein said search step includes determining, as a network device group that does not support any network-compatible Plug and Play function, a network device group which remains after excluding network devices detected as a search result of a UPnP network protocol from a network device group detected by a search of an SNMP protocol.

28. The method according to claim 20, wherein the network device is a network printer.

29. The method according to claim 28, wherein, when the network device supports a plurality of printer languages, said step of generating and returning includes responding as a logically virtual network-compatible Plug and Play printer which is independent for each individual printer language.

30. A network device management apparatus which manages a network device connected to a network, the device having a plurality of functions, said apparatus comprising:
processing means for receiving and processing a request regarding the network device; and
response means for, when a request regarding the network device is received by said processing means, returning a plurality of identification data, each of the identification data corresponding to a respective one of the plurality of functions of the network device,
wherein the plurality of identification data to be returned by said response means is used for installing a plurality of device drivers corresponding to the plurality of functions of the network device.

31. The apparatus according to claim 30, wherein the network device supports a plurality of printing languages, each of the plurality of identification data corresponding to a respective one of the plurality of printing languages.

32. A method for controlling a network device management apparatus which manages a network device connected to a network, the device having a plurality of functions, said method comprising:
a response step of, when a request with regarding to the network device is received, returning a plurality of identification data, each of the identification data corresponding to a respective one of the plurality of functions of the network device,
wherein the plurality of identification data to be returned in said response step is used for installing a plurality of device drivers corresponding to the plurality of functions of the network device.

33. The method according to claim 32, wherein the network device supports a plurality of printing languages, each of the plurality of identification data corresponding to a respective one of the plurality of printing languages.

34. A computer-readable storage medium storing a computer program for causing a computer to perform the steps of the method of claim 32.
